(19) United States
(12) Patent Application Publication
(10) Pub. No.: US 2008/0242785 A1
(43) Pub. Date: Oct. 2, 2008

(54) TiO2-coated CNT, TiO2-coated CNT reinforced polymer composite and methods of preparation thereof

(75) Inventors: Chen-Chi Martin Ma, Hsinchu (TW); Siu-Ming Yuen, Hsinchu (TW); Chia-Yi Chuang, Hsinchu (TW)

Correspondence Address: BACON & THOMAS, PLLC, 625 SLATERS LANE, FOURTH FLOOR, ALEXANDRIA, VA, 22314-1176, US

(73) Assignee: National Tsing Hua University, Hsinchu (TW)

(21) Appl. No.: 11/812,405

(22) Filed: Jun. 19, 2007

(30) Foreign Application Priority Data
Mar. 27, 2007 (TW) 96110651

(51) Int. Cl. C08L 23/02; B29D 22/00

(52) U.S. Cl. 524/413; 428/34.1; 427/443.2; 977/745

(57) ABSTRACT

A method of preparing carbon nanotube/polymer composite is disclosed, which includes: forming a layer of TiO₂ on carbon nanotubes (CNTs) with a precursor of TiO₂ by a sol-gel or hydrothermal method, a weight ratio of the TiO₂ precursor to CNT being 0.3:1 to 30:1; modifying the TiO₂-coated CNTs with a coupling agent to improve the affinity thereof to a polymer; and mixing a polymer with the resulting modified TiO₂-coated CNTs to form a TiO₂-coated CNT reinforced polymer composite. The mechanical properties of the polymer composite can be enhanced by using an additional fiber reinforcement material.

### FIELD OF THE INVENTION

The present invention provides TiO₂-coated CNT-reinforced polymer (e.g. epoxy resin) composites and a method of preparation thereof.

### BACKGROUND OF THE INVENTION

USP 2005/0025694 A1 has discloses a method for stably dispersing carbon nanotubes (CNTs) in an aqueous solution or oil, wherein the CNTs can be multi-walled or single-walled. According to the invention, there is no need of modifying the surface of CNTs into hydrophilic nature. The disclosed method only requires adding a selective dispersion agent and then the resulting mixture is mixed and dispersed using ultrasonic oscillation or a high shear homogenizer rotating at a high speed for achieving the objective of uniformly dispersing CNTs in the aqueous solution. A dispersion agent with an HLB value less than 8 is chosen if the CNTs are to be dispersed in oil; a dispersion agent with an HLB value greater than 10 is chosen if the CNTs are to be dispersed in the water phase.

According to CN 1667040 A1, the surfaces of CNTs are modified by at least a coupling agent selected from the group consisting of a silane coupling agent and a titanate coupling agent in an organic solvent which is selected from the group consisting of xylene, n-butanol, and cyclohexanone. After thorough mixing, the mixture is added with at least a dispersion agent selected from the group consisting of polypriopionate and modified polyurethane. After receiving an ultrasonic treatment, the mixture is uniformly dispersed in an epoxy resin by using a high speed agitation disperser. According to this modification/dispersion method, CNTs are dispersed easily, uniformly, and stably. The resulting CNT/polymer composites are a good antistatic material with good corrosion resistance, heat resistance, solvent resistance, high strength, and high adhesion.

USP 2004/0136894 A1 provides a method for dispersing CNTs in liquid or polymer, which comprises modifying the surfaces of CNTs by adding nitric acid to CNTs and refluxing the resulting mixture in 120° C. oil bath for 4 hours, so that functional groups are grafted onto the defective sites on the surfaces of the CNTs; adding a polar volatile solvent as medium to disperse the modified CNTs therein by stirring with a stirrer or ultrasonication with help from a polar force from the solvent which is able to dissolve a polymer or resin to be added; and adding the polymer or resin to the resulting dispersion, and evaporating the solvent to obtain uniform dispersion of the CNTs in the polymer or resin.

USP 2006/0058443 A1 discloses a composite material with reinforced mechanical strength by using CNTs. According to the invention, CNTs receive ultraviolet irradiation first, followed by a plasma treatment or treated with an oxidization agent, e.g. sulfuric acid or nitric acid, in order to obtain CNTs with hydrophilic groups. Subsequently, a surfactant is used to disperse the hydrophilic CNTs in a polymeric resin in order to obtain a composite material with reinforced mechanical strength by CNTs.

USP 2006/0052509 A1 discloses a method of preparing a CNT composite without adversely affecting the properties of CNTs per se. According to the invention, the surfaces of CNTs are grafted with a conductive polymer or heterocyclic trimer, which is soluble in water and contain sat least a sulfuric group and carboxylic group. The resulting CNTs are dispersed or dissolved in water, organic solvent, or organic aqueous solution after receiving ultrasonic oscillation. Even after long term storage, such a dispersion or solution will not develop agglomeration. Furthermore, such a composite material has good conductivity and film formation properties, and is easy to be coated or used as a substrate.

### SUMMARY OF THE INVENTION

An objective of the present invention is to provide a non-acid-modified CNT, which can be used to improve the affinity between a polymer and the CNT.

Another objective of the present invention is to provide a method of enhancing mechanical strength of resins and polymer prepregs with TiO₂-coated CNTs modified by a coupling agent.

According to the invention, a sol-gel method or hydrothermal method is used to coat CNTs with TiO₂. Furthermore, the TiO₂-coated CNTs are modified with a coupling agent to endow the TiO₂-coated CNTs with affinity to polymer substrates. The modified TiO₂-coated CNTs can be used as an additive in polymers or ceramic materials for increase the mechanical strength of the resulting composite materials. The CNT/polymer composite material prepared according to the present invention can be used to impregnate fiber cloth to form a prepreg material.

Preferred embodiments include (but not limited to) the following Items 1-22:
1. A TiO₂-coated carbon nanotube (CNT) comprising a single-walled or multi-walled CNT, and a TiO₂ coating on a surface of the CNT.
2. The TiO₂-coated CNT as described in Item 1, wherein the TiO₂ coating has a thickness of 2-30 nm.
3. The TiO₂-coated CNT as described in Item 1, wherein the TiO₂ is anatase type.
4. A TiO₂-coated CNT reinforced polymer composite comprising a polymer matrix and TiO₂-coated carbon nanotubes (CNTs) dispersed in the polymer matrix, wherein the TiO₂-coated CNTs comprise single-walled or multi-walled CNTs and a TiO₂ coating located on the surface of the carbon nanotube; wherein a weight ratio of the TiO₂-coated CNTs to the polymer matrix is 0.1:100 to 5:100.
5. The composite as described in Item 4, wherein the TiO₂-coated CNTs further comprises a coupling agent bonded to the TiO₂ coating, wherein the coupling agent is used to improve the dispersion of the TiO₂-coated CNTs in the polymer matrix, and a weight ratio of the coupling agent to the TiO₂-coated CNTs is 5:100 to 200:100.
6. The composite as described in Item 4, wherein the coupling agent is silane.
7. The composite as described in Item 4, wherein the coupling agent is(3-aminopropyl) triethoxysilane (APTES), vinyltriethoxysilane, 3-isocyanato-propyltriethoxysilane, diethylphosphatoethyltriethoxysilane, 2-(diphenyl phosphino)ethyltriethoxysilane, phenyltrimethoxysilane, phenyltriethoxysilane, (3-(methylamino)propyl)trimethoxysilane, diethoxydiethylsilane, diethoxydimethylsilane, diethoxy(methyl)vinylsilane, 1,3-diethoxy-1,1,3,3-tetramethyldisiloxane, dimethoxydimethylsilane, dimethoxymethylvinylsilane, chloro-methoxy-dimethylsilane, ethoxy(dimethyl)vinylsilane, ethoxytrimethylsilane, methoxytrimethylsilane, diethoxydiethylsilane, diethoxydimethylsilane, diethoxy(methyl)vinylsilane, 1,2-bis(triethoxysilyl)ethane, 1,2-bis(trimethoxysilyl)ethane, (chloromethyl)triethoxysilane, 1,3-dimethyltetramethoxydisiloxane, ethyltrimethoxysilane, triethoxy(ethyl)silane, triethoxymethylsilane, trimethoxy(vinyl)silane, trimethoxymethylsilane, bis(trichlorosilyl)acetylene, 1,2-bis(trichlorosilyl)ethane, bis(trichlorosilyl)methane, tert-butyltrichlorosilane, ethyltrichlorosilane, hexachlorodisilane, methyltrichlorosilane, or trichloro(dichloromethyl)silane.
8. The composite as described in Item 4, wherein the polymer matrix is epoxy resin, phenolic resin, polyimide, poly(amide imide), polypropylene, polyethylene, polystyrene, polyurethane, unsaturated polyester, acrylonitrile-butadiene-styrene copolymer, poly(ethylene terephthalate, polyamide, poly(ether ether keton), poly(ether sulfone), poly(ether imide), S-polystyrene, polyethylene naphthalate, polycarbonate, liquid crystal polymer, modified polyphenyleneoxide, or polyphenylene sulfide.
9. The composite as described in Item 4, wherein the TiO₂ coating has a thickness of 5-10 nm.
10. The composite as described in Item 4, wherein the TiO₂ is anatase type.
11. A method for preparing a TiO₂-coated carbon nanotube (CNT), which comprises the following steps: (a) dispersing a single-walled or multi-walled CNT in a liquid medium; (b) dissolving or dispersing a TiO₂ precursor in the resulting dispersion from Step (a), wherein a weight ratio of the TiO₂ precursor to the CNT is 30:100 to 30:1; and (c) reacting the TiO₂ precursor under hydrothermal conditions or sol-gel conditions to form a TiO₂ coating on a surface of the CNT.
12. The method as described in Item 11 further comprises the following step: (d) calcining the TiO₂-coated CNT obtained from Step (c).
13. The method as described in Item 11 wherein the liquid medium in Step (a) is alcohol; the precursor of TiO₂ in Step (b) is titanium alkoxide; and in Step (c) the TiO₂ precursor is reacted under the sol-gel conditions to form the TiO₂ coating, wherein the sol-gel conditions comprise adding water to the resulting mixture from Step (b) and undergoing hydrolysis and condensation reactions of the titanium alkoxide.
14. The method as described in Item 11, wherein the liquid medium in Step (a) is water; the TiO₂ precursor in Step (b) is titanium tetrahalide or titanium inorganic acid salt, and in the Step (c) the TiO₂ precursor is reacted under the hydrothermal conditions to form the TiO₂ coating, wherein the hydrothermal conditions comprise reacting the TiO₂ precursor in an autoclave at 100-300° C. for 0.5-6 hours.
15. The method as described in Item 14, wherein the TiO₂ precursor in Step (b) is TiO(SO₄), and the hydrothermal conditions in Step (c) comprise reacting at 200° C. for 1-4 hours.
16. The method as described in Item 14, wherein the TiO₂ coating has a thickness of 1-100 nm.
17. The method as described in Item 12, wherein the calcining in Step (d) is carried out at 300-1000° C. for 1-3 hours.
18. A method for preparing a TiO₂-coated carbon nanotube (CNT) reinforced polymer composite, which comprises the following steps: (A) dispersing TiO₂-coated carbon nanotubes (CNTs) in an organic solvent, said TiO₂-coated carbon nanotube comprising a single-walled or multi-walled CNT, and a TiO₂ coating on a surface of the carbon nanotube; (B) adding a coupling agent, an acid and water to the resulting dispersion from Step (A), reacting at a temperature from room temperature to 80° C. for 2-48 hours; (C) subjecting the reaction mixture from Step (B) to a solid-liquid separation to obtain modified TiO₂-coated CNTs; and (D) mixing the modified TiO₂-coated CNTs with a polymer, wherein a weight ratio of the coupling agent to the TiO₂-coated CNTs is 5:100 to 200:100, and a weight ratio of the TiO₂-coated CNTs to the polymer is 0.1:100 to 5: 100.
19. The method as described in Item 18, wherein the coupling agent is silane and the acid is an inorganic acid, wherein a weight ratio of the acid to the TiO₂-coated CNTs is 0.3:100 to 10:100, and a weight ratio of water to the TiO₂-coated CNTs is 5:1 to 200:1.
20. The method as described in Item 18, wherein the organic solvent is isopropanol.
21. The method as described in Item 18, wherein the polymer is as defined in claim 8.
22. The method as described in Item 19, wherein the coupling agent is as defined in claim 7.

### BRIEF DESCRIPTION OF THE DRAWINGS

FIG. 1 shows a transmission electron microscopy (TEM) photo of TiO₂-coated CNTs obtained from Step 2 of Example 1 of the present invention;

FIG. 2 shows an X-ray photoelectron spectroscopy (XPS) of TiO₂-coated CNTs obtained from Step 2 of Example 1 of the present invention;

FIG. 3a shows a SEM photo of unmodified CNTs/epoxy nano composite material obtained in Control Example 5; and

FIG. 3b shows a SEM photo of modified TiO₂-coated CNTs/epoxy nano composite material obtained from Step 7 of Example 1 of the present invention.

### DETAILED DESCRIPTION OF THE INVENTION

Modified CNTs and a CNT/epoxy resin composite material prepared according to one of the preferred embodiments of the present invention will be described in the following. The modified CNTs were prepared by the following steps:
a) Dispersing CNTs in isopropanol, wherein the weight ratio of CNTs to isopropanol was about 1:100;
b) To the CNT dispersion prepared in Step (a) into alcohol titanate (titanium alkoxide) (a precursor of TiO₂) was added dropwise, wherein the ratio of the TiO₂ precursor and CNT was 0.3:1 to 30:1; further adding distilled water into the mixture dropwise and stirring the mixture at room temperature for 48 hours or at 60° C. for 4 hours so that the CNTs were coated with a layer of TiO₂;
c) Calcining the TiO₂-coated CNTs prepared in Step (b) at 300° C. to densify the TiO₂ coating layer;
d) Re-dispersing the TiO₂-coated CNTs prepared in Step (c) in isopropanol; adding a coupling agent, water and hydrochloric acid into the dispersion dropwise and stirring the mixture at room temperature for 48 hours or at 60° C. for 4 hours to binding the coupling agent to the TiO₂-coating, thereby obtaining modified CNTs.

The modified TiO₂-coated CNTs have improved affinity to polymer and can be added into polymer to prepare a CNT/polymer composite with enhanced mechanical strength. Such a CNT/polymer composite can be added with other fiber reinforcing material to further enhance the mechanical properties thereof.

Materials used in the following examples and controls were:
Multi-Walled CNT (abbreviated as MWCNT) produced by The CNT Company, Inchon, Korea. This type of CNT was prepared by a CVD process. The CNTs had a purity of 93%, a diameter of 10-50 nm, a length of 1-25 μm, and a specific surface area of 150-250 m²g⁻¹.
Titanium (IV) n-butoxide prepared by the Acros Organics Company, N.J., the U.S.A.
Coupling agent: (3-aminopropyl)triethoxysilane (abbreviated as APTES) prepared by the Lancaster Synthesis Co., Morecambe, United Kingdom.
Epoxy resins: Epoxy resin (1) with a code name of Epon 828 was provided by the Nan Ya Plastic Company, Taiwan; Epoxy resin (2) with a code name of WH-1P001 was provided by the Wah Hong Industrial Corp, Taiwan.
Hardener: 4,4′-Diaminodiphenyl Sulfone provided by the Chris KEV Company, Inc., Terrance Leawood, Kans., U.S.A.

### EXAMPLE 1

### TiO₂-coated CNTs

1.10 g of CNTs were dispersed in 1000 g of isopropanol; 3 g of titanium (IV) n-butoxide was dripped into the resulting dispersion; next, 500 g of pure water was dripped into the mixture; and the resulting mixture was stirred for 48 hours.
2. The CNTs were filtered, dried, and calcined at 300° C. for 1 hour.
3. The TiO₂-coated CNTs (10 g) were re-dispersed in 1000 g of isopropanol. 3 g of APTES was dripped into the resulting dispersion (CNTs: APTES=1:0.3). Next, 500 g of pure water and 1 ml of HCl were dripped into the mixture. Then, the resulting mixture was stirred for 48 hours.
4. The CNTs were filtered and dried (100° C./24 hr, 300° C./i hr).
5. The resulting APTES-modified, TiO₂-coated CNTs (0.04 g) were dispersed in acetone (1000 ml), to which 3 g of Epon 828 and 1 g of 4,4′-diaminodiphenyl sulfone were added (the content of CNTs being 1.0 phr).
6. The resulting CNTs/epoxy resin mixture was dried in a vacuum oven.
7. The resulting CNTs/epoxy resin composite material was poured into an aluminum plate and reacted at 150° C. for 4 hours and at 180° C. for 1 hour.

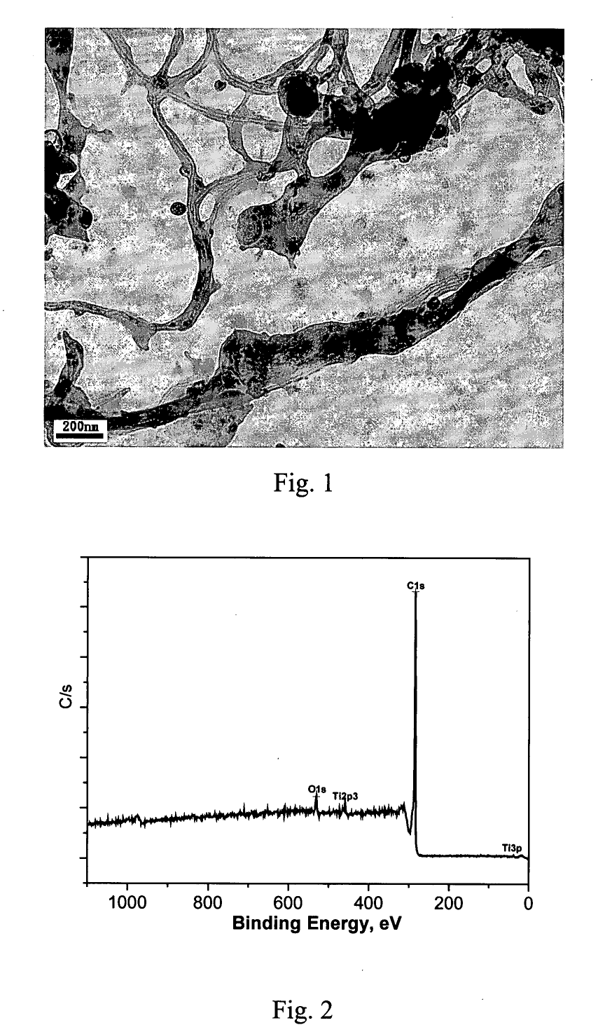

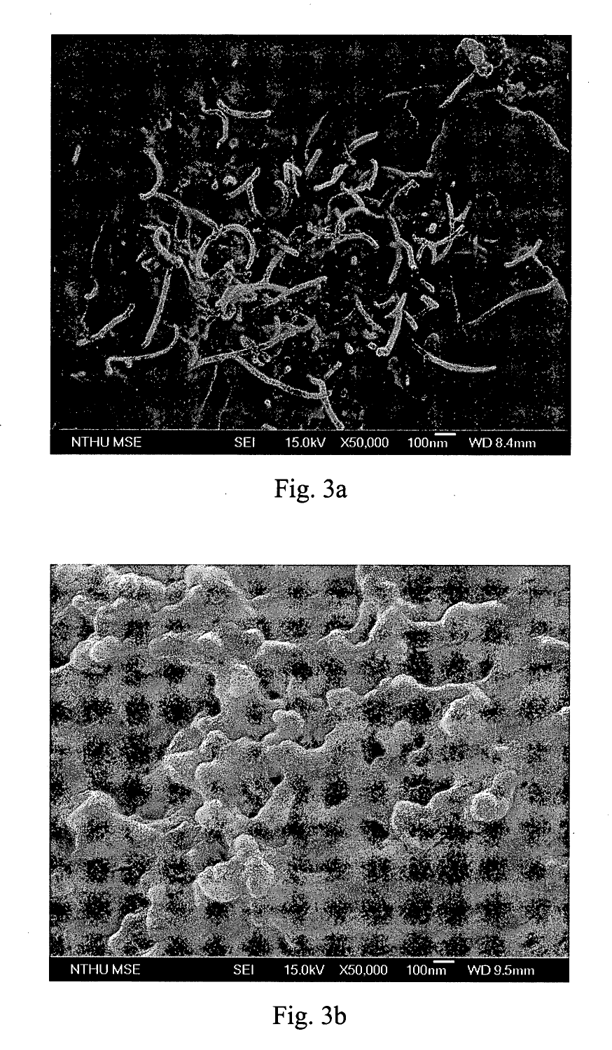

FIG. 1 shows a transmission electron microscopy (TEM) photo of TiO₂-coated CNT obtained from Step 2, which indicates that the CNT is coated with a layer of TiO₂, wherein the thickness of the TiO₂ coating layer is 5-10 nm. FIG. 2 shows an X-ray photoelectron spectroscopy (XPS) of TiO₂-coated CNT obtained from Step 2, wherein the signals at the binding energy of 459 eV is Ti2p3 and at 38 eV is Ti3p. FIG. 1 and FIG. 2 prove the formation of TiO₂ layer on the surface of CNT. FIG. 3a is a scanning electron microscopy (SEM) photo showing a ruptured cross-section by elongation of an unmodified CNT/epoxy nano composite material obtained in the following Control Example 5; FIG. 3b is a SEM photo showing a ruptured cross-section by elongation of a modified TiO₂-coated CNT/epoxy nano composite material obtained from Step 7. In comparison with FIG. 3a to FIG. 3b it can be seen that the unmodified CNTs are agglomerated in and exposed from the matrix epoxy resin in FIG. 3a. These phenomena indicate that the unmodified CNTs are easily pulled out from the matrix epoxy resin. On contrast the modified TiO₂-coated CNTs are integrated into the matrix epoxy resin and not exposed in FIG. 3b. This indicates that the modified TiO₂-coated CNTs are not easily to be pulled out from the matrix epoxy resin. This result proves that the modified TiO₂-coated CNTs have better affinity to the matrix epoxy resin.

### EXAMPLES 2-4

The steps of Example 1 were repeated with different contents of the modified TiO₂-coated CNTs, wherein:

the content of modified TiO₂-coated CNTs in Example 2 was 0.01 g (0.25 phr, i.e. 0.25 parts of CNTs per 100 parts of resin);

the content of modified TiO₂-coated CNTs in Example 3 was 0.02 g (0.5 phr); and

the content of modified TiO₂-coated CNTs in Example 4 was 0.03 g (0.75 phr).

### CONTROL EXAMPLES 1-5

Steps 5 to 7 in Example 1 were repeated to prepare un-modified CNTs/epoxy nano composite materials, except that the modified TiO₂-coated CNTs was replaced with unmodified CNTs, or no CNTS was used, wherein:

No CNT was used in Control Example 1;

the content of unmodified CNTs in Control Example 2 was 0.01 g (0.25 phr);

the content of unmodified CNTs in Control Example 3 was 0.02 g (0.5 phr);

the content of unmodified CNTs in Control Example 4 was 0.03 g (0.75 phr); and

the content of unmodified CNTs of Control Example 5 was 0.04 g (1.0 phr).

Mechanical properties: Test of Flexural strength

### Method of Test: ASTM D790;

### Results:

Table 1 shows the flexural strength and modulus of the modified TiO₂-coated CNTs/epoxy composite materials (Examples 1-4). Table 2 shows the flexural strength and modulus of the epoxy resin containing no CNTs and the unmodified CNTs/epoxy composite materials (Control Examples 1-5).

TABLE 1

| | Content of modified | | |
|---|---|---|---|
| | TiO₂-coated | Flexural strength, | Flexural |
| | MWCNT, phr | MPa | modulus, GPa |
| Example 1 | 1.00 | 110.27 | 3.28 |
| Example 2 | 0.25 | 90.20 | 3.22 |
| Example 3 | 0.50 | 116.54 | 3.41 |
| Example 4 | 0.75 | 112.16 | 3.46 |

TABLE 2

| | Content of | | |
|---|---|---|---|
| | un-modified | Flexural strength, | Flexural modulus, |
| | MWCNT, phr | MPa | GPa |
| Control 1 | 0.00 | 60.37 | 1.87 |
| Control 2 | 0.25 | 72.57 | 2.15 |
| Control 3 | 0.50 | 81.04 | 2.52 |
| Control 4 | 0.75 | 87.48 | 2.31 |
| Control 5 | 1.00 | 50.06 | 2.04 |

The data of Table 1 and Table 2 show that the modified TiO₂-coated CNTs have a better effect in increasing the flexural strength and modulus of a composite material than the unmodified CNTs.

Mechanical properties: Test of Tensile Strength

### Method of Test: ASTM D638

### Results:

Table 3 shows the tensile strength and modulus of modified TiO₂-coated CNTs/epoxy composite materials (Examples 1-4). Table 4 shows that tensile strength and modulus of epoxy resin containing no CNTs and unmodified CNTs/epoxy composite materials (Control Examples 1-5).

TABLE 3

| | Content of modified | | |
|---|---|---|---|
| | TiO₂-coated | Tensile strength, | Tensile modulus, |
| | MWCNT, phr | MPa | GPa |
| Example 1 | 1.00 | 31.05 | 1.80 |
| Example 2 | 0.25 | 33.84 | 2.22 |
| Example 3 | 0.50 | 36.53 | 2.08 |
| Example 4 | 0.75 | 30.60 | 2.03 |

TABLE 4

| | Content of | | |
|---|---|---|---|
| | un-modified | Tensile strength, | Tensile modulus, |
| | MWCNT, phr | MPa | GPa |
| Control 1 | 0 | 16.92 | 1.40 |
| Control 2 | 0.25 | 16.03 | 1.46 |
| Control 3 | 0.50 | 27.85 | 1.47 |
| Control 4 | 0.75 | 25.35 | 1.44 |
| Control 5 | 1.00 | 19.48 | 1.03 |

The data of Table 3 and Table 4 show that the modified TiO₂-coated CNTs have a better effect in increasing the tensile strength and modulus of a composite material than the unmodified CNTs.

1. A TiO₂-coated carbon nanotube (CNT) comprising a single-walled or multi-walled CNT, and a TiO₂ coating on a surface of the CNT.

2. The TiO₂-coated CNT as claimed in claim 1, wherein the TiO₂ coating has a thickness of 2-30 nm.

3. The TiO₂-coated CNT as claimed in claim 1, wherein the TiO₂ is anatase type.

4. A TiO₂-coated CNT reinforced polymer composite comprising a polymer matrix and TiO₂-coated carbon nanotubes (CNTs) dispersed in the polymer matrix, wherein the TiO₂-coated CNTs comprise single-walled or multi-walled CNTs and a TiO₂ coating located on the surface of the carbon nanotube; wherein a weight ratio of the TiO₂-coated CNTs to the polymer matrix is 0.1:100 to 5:100.

5. The composite as claimed in claim 4, wherein the TiO₂-coated CNTs further comprises a coupling agent bonded to the TiO₂ coating, wherein the coupling agent is used to improve the dispersion of the TiO₂-coated CNTs in the polymer matrix, and a weight ratio of the coupling agent to the TiO₂-coated CNTs is 5:100 to 200:100.

6. The composite as claimed in claim 4, wherein the coupling agent is silane.

7. The composite as claimed in claim 4, wherein the coupling agent is(3-aminopropyl) triethoxysilane (APTES), vinyltriethoxysilane, 3-isocyanato-propyltriethoxysilane, diethylphosphatoethyltriethoxysilane, 2-(diphenyl phosphino)ethyltriethoxysilane, phenyltrimethoxysilane, phenyltriethoxysilane, (3-(methylamino)propyl)trimethoxysilane, diethoxydiethylsilane, diethoxydimethylsilane, diethoxy(methyl)vinylsilane, 1,3-diethoxy-1,1,3,3-tetramethyldisiloxane, dimethoxydimethylsilane, dimethoxymethylvinylsilane, chloro-methoxy-dimethylsilane, ethoxy(dimethyl)vinylsilane, ethoxytrimethylsilane, methoxytrimethylsilane, diethoxydiethylsilane, diethoxydimethylsilane, diethoxy(methyl)vinylsilane, 1,2-bis(triethoxysilyl)ethane, 1,2-bis(trimethoxysilyl)ethane, (chloromethyl)triethoxysilane, 1,3-dimethyltetramethoxydisiloxane, ethyltrimethoxysilane, triethoxy(ethyl)silane, triethoxymethylsilane, trimethoxy(vinyl)silane, trimethoxymethylsilane, bis(trichlorosilyl)acetylene, 1,2-bis(trichlorosilyl)ethane, bis(trichlorosilyl)methane, tert-butyltrichlorosilane, ethyltrichlorosilane, hexachlorodisilane, methyltrichlorosilane, or trichloro(dichloromethyl)silane.

8. The composite as claimed in claim 4, wherein the polymer matrix is epoxy resin, phenolic resin, polyimide, poly(amide imide), polypropylene, polyethylene, polystyrene, polyurethane, unsaturated polyester, acrylonitrile-butadiene-styrene copolymer, poly(ethylene terephthalate, polyamide, poly(ether ether keton), poly(ether sulfone), poly(ether imide), S-polystyrene, polyethylene naphthalate, polycarbonate, liquid crystal polymer, modified polyphenyleneoxide, or polyphenylene sulfide.

9. The composite as claimed in claim 4, wherein the TiO₂ coating has a thickness of 5-10 nm.

10. The composite as claimed in claim 4, wherein the TiO₂ is anatase type.

11. A method for preparing a TiO₂-coated carbon nanotube (CNT), which comprises the following steps: (a) dispersing a single-walled or multi-walled CNT in a liquid medium; (b) dissolving or dispersing a TiO₂ precursor in the resulting dispersion from Step (a), wherein a weight ratio of the TiO₂ precursor to the CNT is 30:100 to 30:1; and (c) reacting the TiO₂ precursor under hydrothermal conditions or sol-gel conditions to form a TiO₂ coating on a surface of the CNT.

12. The method as claimed in claim 11 further comprises the following step: (d) calcining the TiO₂-coated CNT obtained from Step (c).

13. The method as claimed in claim 11, wherein the liquid medium in Step (a) is alcohol; the precursor of TiO₂ in Step (b) is titanium alkoxide; and in Step (c) the TiO₂ precursor is reacted under the sol-gel conditions to form the TiO₂ coating, wherein the sol-gel conditions comprise adding water to the resulting mixture from Step (b) and undergoing hydrolysis and condensation reactions of the titanium alkoxide.

14. The method as claimed in claim 11, wherein the liquid medium in Step (a) is water; the TiO₂ precursor in Step (b) is titanium tetrahalide or titanium inorganic acid salt, and in the Step (c) the TiO₂ precursor is reacted under the hydrothermal conditions to form the TiO₂ coating, wherein the hydrothermal conditions comprise reacting the TiO₂ precursor in anautoclave at 100-300° C. for 0.5-6 hours.

15. The method as claimed in claim 14, wherein the TiO₂ precursor in Step (b) is TiO(SO₄), and the hydrothermal conditions in Step (c) comprise reacting at 200° C. for 1-4 hours.

16. The method as claimed in claim 14, wherein the TiO₂ coating has a thickness of 1-100 nm.

17. The method as claimed in claim 12, wherein the calcining in Step (d) is carried out at 300-1000° C. for 1-3 hours.

18. A method for preparing a TiO₂-coated carbon nanotube (CNT) reinforced polymer composite, which comprises the following steps: (A) dispersing TiO₂-coated carbon nanotubes (CNTs) in an organic solvent, said TiO₂-coated carbon nanotube comprising a single-walled or multi-walled CNT, and a TiO₂ coating on a surface of the carbon nanotube; (B) adding a coupling agent, an acid and water to the resulting dispersion from Step (A), reacting at a temperature from room temperature to 80° C. for 2-48 hours; (C) subjecting the reaction mixture from Step (B) to a solid-liquid separation to obtain modified TiO₂-coated CNTs; and (D) mixing the modified TiO₂-coated CNTs with a polymer, wherein a weight ratio of the coupling agent to the TiO₂-coated CNTs is 5:100 to 200:100, and a weight ratio of the TiO₂-coated CNTs to the polymer is 0.1:100 to 5:100.

19. The method as claimed in claim 18, wherein the coupling agent is silane and the acid is an inorganic acid, wherein a weight ratio of the acid to the TiO₂-coated CNTs is 0.3:100 to 10:100, and a weight ratio of water to the TiO₂-coated CNTs is 5:1 to 200:1.

20. The method as claimed in claim 18, wherein the organic solvent is isopropanol.

21. The method as claimed in claim 18, wherein the polymer is as defined in claim 8.

22. The method as claimed in claim 19, wherein the coupling agent is as defined in claim 7.
